(19) United States
(12) Patent Application Publication
(10) Pub. No.: US 2004/0235998 A1
(43) Pub. Date: Nov. 25, 2004

(54) Liquid crystalline polymer composition

(76) Inventor: Olaf Norbert Kirchner, Geneva (CH)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/836,664

(22) Filed: Apr. 30, 2004

Related U.S. Application Data
(60) Provisional application No. 60/468,937, filed on May 8, 2003.

(51) Int. Cl. C 08L 1 1/00

(52) U.S. Cl. 524/431; 524/496; 524/497

(57) ABSTRACT

A black colored liquid crystalline polymer composition comprising specified amounts of carbon black, another black pigment, a filler having nanometer sized particles, and optionally other ingredients has a relatively high comparative tracking index (resistance to higher voltages), and is useful in electrical and electronic apparatuses where such voltages are present.

### CROSS REFERENCE TO RELATED APPLICATIONS

This application claims the benefit of U.S. Provisional Application No. 60/468,937, filed May 8, 2003.

### FIELD OF THE INVENTION

Black colored liquid crystalline polymer (LCP) or isotropic polymer compositions having good resistance to relatively high voltages comprise an LCP, a nonconductive black filler, carbon black, and nanometer-sized particles, and optionally other ingredients, in specified amounts.

### TECHNICAL BACKGROUND

Liquid crystalline polymers (LCPs) and isotropic polymers have become important items of commerce, being useful as molding resins for general purpose uses, and more specifically in the electrical and electronics industries due to their thermal stability, chemical resistance, and other desirable properties. For many electrical and electronics applications, the molding resins should exhibit good tracking resistance and other properties, for instance good flame-retarding properties.

Tracking is a phenomenon associated with the formation of permanent and progressive conducting paths on the surface of materials, usually by the combined effects of an electrical field and external surface pollution. Electrical tracking can occur when a damaged energized electrical part becomes wet, e.g., from electrolytes or condensation. This tracking may lead to flash over and arcing that causes further damage in the electrical part, eventually causing a catastrophic cascade failure. Tracking can occur at low voltages, e.g., 100V AC or less but becomes less likely as the voltage is reduced. The comparative tracking index (CTI) rating provides a quantitative indication of a composition's ability to perform as an electrical insulating material under wet and/or contaminated conditions. In determining the CTI rating of a resin composition, two electrodes are placed on a molded test specimen. A voltage differential is then established between the electrodes while an aqueous ammonium chloride solution is slowly dripped on the test specimen. The CTI rating of the test specimen is the maximum electrode voltage differential at which, in five consecutive tests, more than 50 drops of the solution must be applied to the test specimen in order to cause tracking to occur. Hence, the CTI value is the voltage at which a molding is found to exhibit conductivity under test conditions. For some applications in the electrical and electronics industry, the CTI value is expected to be at least 150 or 200 volts.

LCP compositions which have a good CTI are known, see WO02/02717. The compositions described in this reference are generally white or light gray. It is sometimes desirable to use a composition whose color is black. The most common material for coloring thermoplastic compositions black is carbon black, but carbon black usually has a relatively high electrical conductivity. Filling an LCP or isotropic polymer with carbon black generally lowers its CTI, presumably because the carbon black can act as a conductive material within the composition. Using other black colored fillers is an option, but they do not have the coloring power of carbon black, and use of too large an amount of filler materials can result in lowering other physical properties of the composition excessively. Therefore an LCP (or isotropic polymer) composition which has a high CTI, but is also black, is desired.

### SUMMARY OF THE INVENTION

This invention concerns a composition, comprising,

(a) 0.1 to about 20 weight percent of a particulate material at least 90% of the particles of which have an average particle size of less than about 200 nanometers;

(b) 0.1 to about 40 weight percent of a black particulate material which is not carbon black;

(c) 0.1 to about 10 weight percent of carbon black; and

(d) at least about 35 weight percent of a liquid crystalline polymer;

wherein said weight percents are based on the total weight of said composition, and provided that said composition has a CTI rating of at least about 150 volts.

This invention also concerns a composition, comprising,

(a) 0.1 to about 20 weight percent of a particulate material at least 90% of the particles which have an average particle size of less than about 200 nanometers;

(b) 0.1 to about 40 weight percent of a black particulate material which is not carbon black;

(c) 0.1 to about 10 weight percent of carbon black; and

(d) at least about 35 weight percent of an isotropic polymer;

wherein said weight percents are based on the total weight of said composition, and provided that said composition has a comparative tracking index rating of at least about 150 volts.

### DETAILS OF THE INVENTION

By a “liquid crystalline polymer” is meant a polymer that is anisotropic when tested using the TOT test or any reasonable variation thereof, as described in U.S. Pat. No. 4,118,372, which is hereby included by reference. Useful LCPs include polyesters, poly(ester-amides), and poly(ester-imides). One preferred form of polymer is “all aromatic”, that is all of the groups in the polymer main chain are aromatic (except for the linking groups such as ester groups), but side groups which are not aromatic may be present. Preferably the LCP is at least about 40 weight percent of the composition. Preferably the melting point of the LCP is about 250° C. or higher, more preferably about 300° C. or higher, and especially preferably about 350° C. or higher. Melting point is measured by method ASTM Method D3418. Melting points are taken as the maximum of the melting endotherm, and are measured on the second heat. If more than one melting point is present the melting point of the polymer is taken as the highest of the melting points.

By “carbon black” herein is meant any fine particled material which is predominantly carbon. Useful materials for carbon blacks include short lengths of carbon fibers, furnace blacks, thermal blacks, channel blacks, and lamp blacks. Preferred materials for carbon blacks are carbon blacks themselves. A preferred level of carbon black is about 0.5 to about 2.0 weight percent [unless otherwise stated herein, all weight percents are based on the amounts of all of the ingredients in (total weight of) the composition].

Black pigments may be any finely divided particulate material which is black (visually black or very dark blue in normal sunlight), and is preferably electrically insulating (nonconducting). The black pigment may be an organic or inorganic material, so long as it is reasonably stable at melt processing conditions for the composition. Particles sizes are in ranges typical for fillers and/or reinforcements for plastic materials. Useful black pigments include black iron oxide(Fe₂O₃), mixed-phase black iron oxide (Fe₂O₃) and manganese oxide (Mn₂O₃), iron oxide (Fe₃O₄), silicon carbide (SiC), doped titanium dioxide ilmentite (FeTiO₃), nigrosine, spinel black (Cu(Cr,Fe)₂O₄) and spinel black (Co(Cr,Fe)₂O₄). Preferably the black pigment is black iron oxide [typically mixed-phase black iron oxide (Fe₂O₃) and manganese oxide (Mn₂O₃)]. Preferably the amount of black pigment is about 2.0 to about 10 weight percent. Preferably this material has an average particle size (longest dimension) of about 50 μm or less, more preferably about 4 μm or less. Also preferably the average particle size (longest dimension) is about 0.1 μm or more.

In the nano particled material at least 90% of the particles preferably have an average particle size of about 100 nanometers or less, and more preferably about 50 nanometers or less, and is preferably electrically insulating (nonconducting). The nano particles, such as nano-TiO₂, often consists of agglomerates of primary particles. With such products, the average size of primary particles is ascertained, as it is difficult to measure the average size of the agglomerates. Determining the average size of the primary particles is carried out using electron micrographs of the product to be analyzed. The diameters of 3000-5000 particles are semi-automatically measured. The arithmetical mean then represents the average size of the primary particles. For the measurement of the diameter, only those primary particles are considered where at least one half of the circumference is recognizable. The primary particle size distribution is determined by the TGZ 3 (particle size analyzer) developed by ENDTER and GEBAUER, or an equivalent instrument and software.

Since this size is less than the wavelength of visible light, it appears to be colorless, and does not normally materially contribute to the color of the composition. However, being a fine particled material it does often help improve the CTI rating of the composition. Thus unlike other larger particled fillers it may be added to the composition to improve the CTI while not causing the composition's color to be lightened (for example to a gray color). However most nano particle materials, because of their small size, are expensive, so it is usually preferred to use as little as possible while maintaining the color and other properties desired. Preferably the nano particled material is about 1.0 to about 5.0 weight percent of the composition. A useful nano particle material is TiO₂.

Other materials may also be present in the composition to improve various physical properties (including CTI) or other aspects of the composition. These materials should preferably be electrically insulating (nonconducting). Such materials may include one or more of fillers, reinforcing agents, lubricants, antioxidants, brightening agents, mold release agents, nucleating agents, hydrolytic stabilizers and UV stabilizers. It is preferred that the composition contain about 25 to about 55 weight percent of fillers and/or reinforcing agents (other than those specifically required, above), more preferably about 35 to about 50 weight percent of these materials. Reinforcing agents and/or fillers include fibrous materials such as chopped glass, milled glass, aramid fibers, wollastonite, titanium dioxide whiskers, and powders (particulates) such as TiO₂, mica, clays, calcium sulfate, calcium phosphate, barium sulfate, talc, glass beads and glass flake. Other materials which may be present include other (types of) polymers, to form polymer blends. Some of these materials may act to improve the strength and/or modulus of the composition and/or may improve the CTI and/or flammability resistance (see for instance WO02/02717, which is hereby included by reference). Particularly for LCPs, a preferred reinforcing agent is (short) glass fibers, preferably about 15 to about 55 weight percent, and Preferred fillers are (white) TiO₂ (in the conventional TiO₂ particle size range, not the nano particle size range) preferably about 2 to about 10 weight percent, talc, and milled glass. Again particularly for LCPs a preferred combination of fillers is glass fiber and TiO₂, preferably in the amounts given above. For particulate (as opposed fibrous) fillers and reinforcements, preferably this(these) material(s) has(have) an average particle size (longest dimension) of about 50 μm or less, more preferably about 4 μm or less. Also preferably the average particle size (longest dimension) is about 0.1 μm or more.

Isotropic polymers having a melting point of at least 150° C., preferably at least about 200° C., may be used in place of the LCP. By an isotropic polymer is meant a polymer which is isotropic when tested by the TOT test (see above). However, these polymers may not have the relatively good flammability resistance of the LCPs unless flame retardants are also added. Useful types of isotropic polymers include polyesters, polyamides, polyoxymethylenes, polysulfide, poly(ether-ketones), poly(ether-ether-ketones), poly(ether-ketones-ketones), polyimides, poly(imide-ethers), polysulfones, and fluorinated polymers. In one preferred type of isotropic polymer, IPE (isotropic polyester), the dicarboxylic acids comprise one or more of terephthalic acid, isophthalic acid and 2,6-naphthalene dicarboxylic acid, and the diol component comprises one or more of HO(CH₂)ₙOH (I), 1,4-cyclohexanedimethanol, HO(CH₂CH₂O)ₘCH₂CH₂OH (II), and HO(CH₂CH₂CH₂CH₂O)_{z}CH₂CH₂CH₂CH₂OH (III), wherein n is an integer of 2 to 10, m on average is 1 to 4, and is z an average of about 7 to about 40. Note that (II) and (III) may be a mixture of compounds in which m and z, respectively may vary and hence since m and z are averages, they do not have to be integers. In preferred polyesters, n is 2, 3 or 4, and/or m is 1. Specific preferred isotropic polymers are polyesters, such as poly(ethylene terephthalate), poly(1,3-propylene terephthalate), poly(1,4-butylene terephthalate), and poly(1,4-cyclohexyldimethylene terephthalate).

Preferably the composition has a CTI rating of at least 175 volts, more preferably at least 200 volts, and especially preferably at least about 225 volts. The test for CTI (Comparative Tracking Index) is run according to method IEC 112.

To measure the color of the instant composition the L/a/b scale on a Datacolor® DC3890 instrument is used, the geometry being according to ISO Test Method 2469, 12 mm spot area, D65 diffuse illuminating source 400-700 nm at 8°, viewing angle 0°, specular included. Preferably L is less than about 40, more preferably L is less than about 37.

Since for many electrical/electronic applications such a composition is preferably flame resistant, it is also preferred that the composition have a UL-94 rating of V-1 at a thickness of 0.79 mm, more preferably a UL-94 rating of V-0 at a thickness of 0.79 mm. These UL-94 ratings are especially applicable to LCPs, although also preferred for isotropic polymers. The UL-94 test (Underwriter's Laboratories) is a relative flammability test for plastics materials, and the requirements for a V-0 rating are more stringent to those for a V-1 rating. The thinner the test piece, the more difficult it is to achieve a higher flammability resistance reading.

Preferably, especially for LCPs, the composition has a Heat Deflection Temperature (HDT) at 1.82 MPa of at least about 240° C., more preferably at least about 265° C. The HDT is measured by ASTM Method D-648.

The compositions described herein may be made and formed into parts by conventional methods used for mixing and forming thermoplastic compositions. The compositions may be made by melt mixing (the LCP or isotropic polymer and any other low melting ingredients are melted) the ingredients in a typical mixing apparatus such as a single or twin screw extruder or a melt kneader. Parts may be formed by typical thermoplastic forming methods such as extrusion, extrusion coating or injection molding.

These compositions are particularly useful in electrical and electronic applications, particularly where voltages in excess of 150 volts, preferably in excess of 200 volts are present, and especially the electrical conductors carrying these voltages are in close proximity to the present compositions, especially if there are no electrical insulators (except air) between these conductors and the present compositions. Such uses include lamp sockets, electrical and electronic connectors, lamp holders, terminal blocks, end connectors, ignition coils, relay sockets, high-voltage connectors, spark plug components, emergency switches, controller and switches for domestic appliances including ovens cookers and washing machines, electric motor brush holders, coil formers, circuit breakers, circuit breaker housings, contactor housings and print connectors, as well as electrical and electronic connectors, distributors, switches and microswitches.

In the Example and the Comparative Examples the LCP used has the same composition as LCP-9 of U.S. Pat. No. 5,110,896. The glass fiber was OCF-408A (Owens-Corning, Inc., Corning, N.Y., USA), the “regular” TiO₂ was Tiona® RCL-4 (Millennium Chemicals, Red Bank, N.J., USA), the nano-TiO₂ was P25 (Degussa, Dusseldorf, Germany), the black iron oxide was Colortherm® 303T (Bayer, Leverkusen Germany), and the lubricant was Licowax® PE190 (Clariant, Frankfurt, Germany), and the carbon black used was in the form of a 50% concentrate in an LCP.

### EXAMPLE 1

The ingredients were fed to Werner and Pfleiderer ZSK-40 40 mm bilobal twin screw extruder, and the temperatures were set to that the melt temperature exiting the extruder was about 380° C. Rectangular plaques (50×40×2 mm) were molded on an Arburg® 250-60 Allrounder® 250-60 injection molding machine, using a clamping force of about 25 tonnes. The melt temperatures was about 380° C., and the mold temperature was about 80° C. The composition (parts by weight) are shown in Table 1, together with the measured CTI and color.

### COMPARATIVE EXAMPLES A AND B

The compositions shown in Table 1 (parts by weight) were molded as described in Example 1. The resulting CTIs and color measurements are also shown in Table 1.

TABLE 1

| Example | 1 | A | B |
|---|---|---|---|
| LCP | 42.7 | 49.8 | 53.8 |
| Glass fiber | 45 | 45 | 45 |
| Regular TiO₂ | 5 | 5 | — |
| nano-TiO₂ | 2 | — | — |
| Black iron oxide | 4 | — | — |
| Carbon black | 1 | — | 1 |
| Lubricant | 0.3 | 0.2 | 0.2 |
| CTI, volts | 175 | 150-175 | 150 |
| L-value (color) | 36.6 | — | 35.4 |

What is claimed is:

1. A composition, comprising,
(a) 0.1 to about 20 weight percent of a particulate material at least 90% of the particles which have an average particle size of less than about 200 nanometers;
(b) 0.1 to about 40 weight percent of a black particulate material which is not carbon black;
(c) 0.1 to about 10 weight percent of carbon black; and
(d) at least about 35 weight percent of a liquid crystalline polymer;
wherein said weight percents are based on the total weight of said composition, and provided that said composition has a comparative tracking index rating of at least about 150 volts.

2. The composition as recited in claim 1 wherein said liquid crystalline polymer has a melting point of about 300° C. or higher.

3. The composition as recited in claim 1 wherein about 0.5 to about 2.0 weight percent of said carbon black is present.

4. The composition as recited in claim 1 wherein about 2.0 to about 10 weight percent of said black particulate material is present.

5. The composition as recited in claim 4 wherein said black particulate material is black iron oxide.

6. The composition as recited in claim 4 wherein said black particulate material has an average particle size of 4 μm or less.

7. The composition as recited in claim 1 wherein said particulate material has an average particle size of 50 nanometers or less.

8. The composition as recited in claim 7 wherein said particulate material is TiO₂.

9. The composition as recited in claim 1 wherein about 1.0 to about 5.0 weight percent of said particulate material is present.

10. The composition as recited in claim 1 additionally comprising TiO₂ not in the nano particle size range and glass fiber.

11. The composition as recited in claim 1 which has said comparative tracking index rating of at least 225 volts.

12. The composition as recited in claim 1 which has UL-94 test rating of V-0 at 0.79 mm thickness.

13. A lamp socket, electrical or electronic connector, lamp holder, terminal block, end connector, ignition coil, relay socket, high-voltage connector, spark plug component, emergency switch, controller or switch for a domestic appliance, electric motor brush holder, coil former, circuit breaker, circuit breaker housing, contactor housing or print connector, or electrical and electronic connector, distributor, switch or microswitch comprising the composition of claim 1.

14. A composition, comprising,
(a) 0.1 to about 20 weight percent of a particulate material at least 90% of the particles which have an average particle size of less than about 200 nanometers;
(b) 0.1 to about 40 weight percent of a black particulate material which is not carbon black;
(c) 0.1 to about 10 weight percent of carbon black; and
(d) at least about 35 weight percent of an isotropic polymer;
wherein said weight percents are based on the total weight of said composition, and provided that said composition has a comparative tracking index rating of at least about 150 volts.

15. The composition as recited in claim 14 wherein about 0.5 to about 2.0 weight percent of said carbon black is present.

16. The composition as recited in claim 14 wherein about 2.0 to about 10 weight percent of said black particulate material is present.

17. The composition as recited in claim 16 wherein said black particulate material is black iron oxide.

18. The composition as recited in claim 16 wherein said black particulate material has an average particle size of 4 μm or less.

19. The composition as recited in claim 17 wherein said particulate material has an average particle size of 50 nanometers or less.

20. The composition as recited in claim 19 wherein said particulate material is TiO₂.

21. The composition as recited in claim 14 wherein about 1.0 to about 5.0 weight percent of said particulate material is present.
